(19) United States
(12) Patent Application Publication
(10) Pub. No.: US 2016/0079856 A1
(43) Pub. Date: Mar. 17, 2016

(54) DC-to-DC converter and converting method of discontinuous conduction mode

(71) Applicant: REALTEK SEMICONDUCTOR CORPORATION, HSINCHU (TW)

(72) Inventor: SHIH-WEI WANG, HUALIEN COUNTY (TW)

(21) Appl. No.: 14/817,856

(22) Filed: Aug. 4, 2015

(30) Foreign Application Priority Data
Sep. 15, 2014 (TW) 103131821

(51) Int. Cl. H02M 3/158

(52) U.S. Cl. CPC H02M 3/158

(57) ABSTRACT

The present invention discloses a DC-to-DC converter of discontinuous conduction mode capable of preventing an inductor current from being reduced to zero under an idle state, comprising: an inductor operable to output the inductor current according to a DC-input signal under an energy-storage state, output the inductor current according to the DC-input signal and a DC-output signal under an energy-release state, and keep the inductor current unchanged under the idle state; a freewheel switch operable to be conductive under the idle state and nonconductive under the energy-storage and energy-release states according to a freewheel-control signal and form a current loop with the inductor; a current sensing circuit operable to detect the inductor current and generate a current-detection signal; and a control circuit operable to generate the freewheel-control signal according to the current-detection signal and control the state of the converter to be the energy-storage state, energy-release state or idle state.

### BACKGROUND OF THE INVENTION

1. Field of the Invention

The present invention relates to a DC-to-DC converter and converting method, especially to a DC-to-DC converter and converting method of discontinuous conduction mode.

2. Description of Related Art

Regarding power management applications, a DC-to-DC (direct current to direct current) converter could be used as a voltage booster or a voltage down-converter. Through a proper design, a voltage booster can operate in a continuous conduction mode (CCM) or a discontinuous conduction mode (DCM), and the difference between the two modes is the waveform of the inductor current of the voltage booster. More specifically, compared to a CCM voltage booster, a DCM voltage booster will operate in an idle state where the inductor current of the booster will be freewheeling by time. A CCM voltage booster is usually used in a design characterized by a relatively low voltage boosting ratio (i.e., the ratio of an output voltage to an input voltage) and a relatively high input current; and a DCM voltage booster is usually used in a design (e.g., a high power lighting device or an optical communication receiver) characterized by a relatively high voltage boosting ratio. Since a voltage boosting ratio is inversely proportional to the current flowing through a load coupled to the concerned voltage booster, the higher the voltage boosting ratio is (, which implies that the circuit path controlling the voltage boosting ratio draws more current), the less the current running through the load is; consequently, the interested circuit driving capability is weakened. Besides, since the inductor current of a conventional DCM voltage booster will be reduced to zero during the mentioned idle state, the capability of the voltage booster to store energy in an energy-storage duration and to release energy in an energy-release duration will be limited.

In addition, since the voltage at an inductor output end of a conventional DCM voltage booster won't immediately be equal to the voltage at an inductor input end (but the two voltages are supposed to be the same ideally) at the moment of entering the idle state and the current running through the concerned inductor won't change instantly, which means that the relation between current variation and time should be continuous, once the inductor current is closed to zero and the inductor output end is floating, the positive and negative directions of the inductor current flow will be exchanged with each other, and thus the signal at the inductor output end during the idle state won't become stable instantly but will approach the voltage value at the inductor input end step-by-step. This phenomenon will cause a conventional DCM voltage booster a problem of high noise.

People who are interested in the prior art may refer to the following document: Hanh-Phuc Le, Chang-Seok Chae, Kwang-Chan Lee, Se-Won Wang, Gyu-Ha Cho, and Gyu-Hyeong Cho, “A Single-Inductor Switching DC-DC Converter With Five Outputs and Ordered Power-Distributive Control”, IEEE JOURNAL OF SOLID-STATE CIRCUITS, VOL. 42, NO. 12, DECEMBER 2007.

### SUMMARY OF THE INVENTION

In view of the problem of the prior art, an object of the present invention is to provide a DC-to-DC converter and converting method of discontinuous conduction mode capable of making an improvement over the prior art.

Another object of the present invention is to provide a DC-to-DC converter and converting method capable of enhancing current drawing capability and noise reduction.

The present invention discloses a DC-to-DC converter of discontinuous conduction mode capable of preventing an inductor current from being reduced to zero under an idle state. An embodiment of the DC-to-DC converter comprises: a signal input end operable to receive a DC input signal; a signal output end operable to output a DC output signal; an inductor including an inductor input end and an inductor output end operable to output an inductor current according to the DC input signal under an energy-storage state, output the inductor current according to the DC input signal and the DC output signal under an energy-release state, and maintain the inductor current under an idle state; a freewheel switch, coupled to the inductor input and output ends, operable to be conductive under the idle state and nonconductive under the energy-storage and energy-release states according to a freewheel control signal so that the freewheel switch and the inductor are operable to form a current loop under the idle state; a conversion switch, coupled between the inductor output end and a first voltage node, operable to be conductive under the energy-storage state and nonconductive under the energy-release and idle states according to a conversion control signal; an isolation element, coupled between the inductor output end and the signal output end, operable to be nonconductive under the energy-storage and idle states and conductive under the energy-release state; a capacitor, coupled between the signal output end and the first voltage node, operable to output a capacitor current to the signal output end under the energy-storage and idle states; a current sensing circuit operable to determine whether the inductor current reaches a current threshold and thereby generate a current detection signal in which the current threshold is above zero; and a control circuit, coupled to the signal output end, the freewheel switch, the conversion switch and the current sensing circuit, operable to generate the conversion control signal according to the DC output signal and generate the freewheel control signal according to the current detection signal.

Another embodiment of the said DC-to-DC converter comprises: a signal input end operable to receive a DC input signal; an output circuit operable to output a DC output signal; an inductor including an inductor input end coupled to the signal input end and an inductor output end coupled to the output circuit, operable to output an inductor current according to the DC input signal under an energy-storage state, output the inductor current according to the DC input signal and the DC output signal under an energy-release state, and maintain the inductor current under an idle state; a freewheel switch, coupled to the inductor input and output ends, operable to be conductive under the idle state and nonconductive under the energy-storage and energy-release states according to a freewheel control signal so that the freewheel switch and the inductor are operable to form a current loop under the idle state; a current sensing circuit operable to determine whether the inductor current reaches a current threshold and thereby generate a current detection signal in which the current threshold is above zero; and a control circuit, coupled to the signal output circuit, the freewheel switch and the current sensing circuit, operable to generate the freewheel control signal according to the current detection signal and control the change of states from one of the energy-storage state, the energy-release state and the idle state to another.

The present invention also discloses a DC-to-DC converting method of discontinuous conduction mode capable of preventing an inductor current from being reduced to zero under an idle state. An embodiment of the method comprises: making an inductor output an inductor current according to a DC input signal under an energy-storage state; making the inductor output the inductor current according to the DC input signal and a DC output signal under an energy-release state; determining whether the inductor current reaches a current threshold during the energy-release state and generate a current detection signal accordingly in which the current threshold is above zero; and if the inductor current reaches the current threshold, making a freewheel switch be conductive to form a current loop with the inductor so that the inductor current will be allowed to circle in the current loop and the inductor current will be maintained under the foresaid idle state.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates an embodiment of the DC-to-DC converter of the present invention.

FIG. 2 illustrates the DC-to-DC converter of FIG. 1 operating in an energy-storage state.

FIG. 3 illustrates the DC-to-DC converter of FIG. 1 operating in an energy-release state.

FIG. 4 illustrates the DC-to-DC converter of FIG. 1 operating in an idle state.

FIG. 5 illustrates the variation of the inductor current of FIG. 2 through FIG. 4.

FIG. 6 illustrates an embodiment of the control circuit of FIG. 1.

FIG. 7 illustrates another embodiment of the DC-to-DC converter of the present invention.

FIG. 8 illustrates an embodiment of the DC-to-DC converting method of the present invention.

### DETAILED DESCRIPTION OF THE PREFERRED EMBODIMENTS

The following description is written by referring to terms acknowledged in this invention field. If any term is defined in the specification, such term should be explained accordingly. Besides, the connection between objects or events in the disclosed embodiments can be direct or indirect provided that these embodiments are still applicable under such connection. Said “indirect” means that an intermediate object or a physical space is existed between the objects, or an intermediate event or a time interval is existed between the events. In addition, the following description relates to a DC-to-DC (direct current to direct current) converter and converting method, and the theory or explanation of the converter and method that have been well known in this field will be omitted if such theory or explanation has little to do with the features of the present invention. Furthermore, the shape, size, and ratio of any element and the step sequence of any flow chart in the disclosed figures are just exemplary for understanding, not limitations in the scope of this invention.

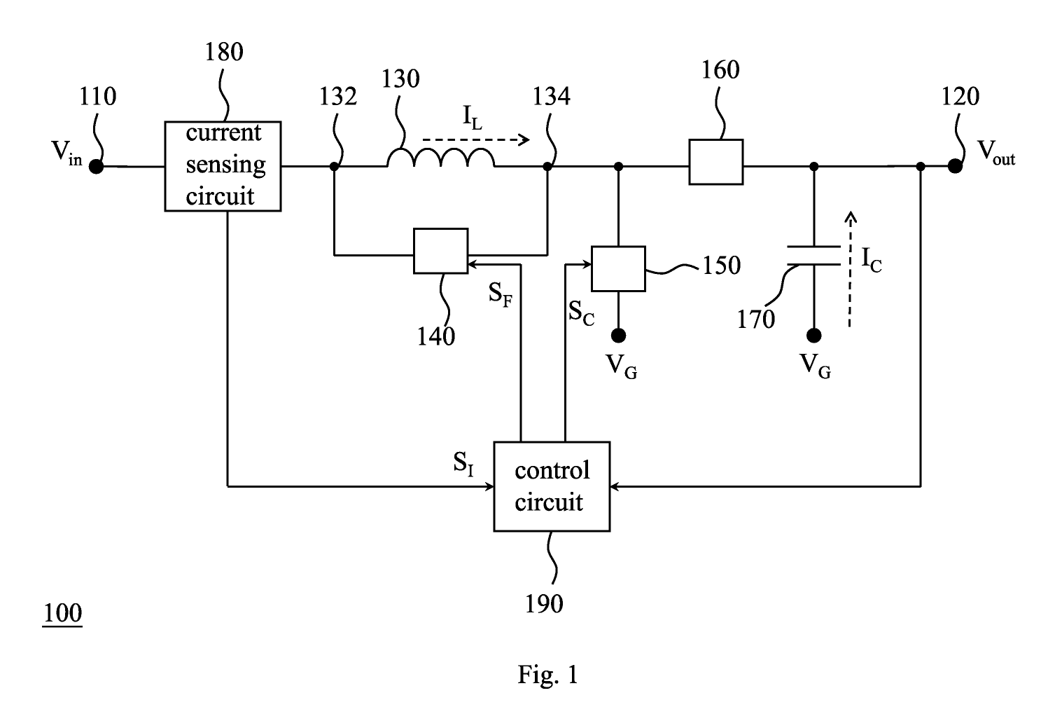

Please refer to FIG. 1 which illustrates an embodiment of the DC-to-DC converter of discontinuous conducting mode (DCM) of the present invention. The DC-to-DC converter 100 in this embodiment is operable to function in an energy-storage state, an energy-release state and an idle state in order within an operation cycle, and operable to prevent an inductor current from being reduced to zero under the said idle state. The DC-to-DC converter 100 comprises: a signal input end 110; a signal output end 120; an inductor 130; a freewheel switch 140; a conversion switch 150; an isolation element 160; a capacitor 170; a current sensing circuit 180; and a control circuit 190. The said signal input end 110 is operable to receive a DC input signal Vᵢₙ. The said signal output end 120 is operable to output a

DC output signal V_{out.} The said inductor 130 includes an inductor input end 132 and an inductor output end 134 operable to output an inductor current I_{L} according to the DC input signal Vᵢₙ under the aforementioned energy-storage state, output the inductor current I_{L} according to the DC input signal Vᵢₙ and the DC output signal Vₒᵤₜ under the aforementioned energy-release state, and maintain the inductor current I_{L} under the aforementioned idle state. The said freewheel switch 140 (e.g., a PMOS transistor or the equivalent thereof) is coupled to the inductor input and output ends 132, 134, and operable to be conductive under the idle state and nonconductive under the energy-storage and energy-release states according to a freewheel control signal S_{F} so that the freewheel switch 140 and the inductor 130 are operable to form a current loop under the idle state. The said conversion switch 150 (e.g., an NMOS transistor or the equivalent thereof) is coupled between the inductor output end 134 and a first voltage node V_{G} (e.g., a grounding voltage node or some reference voltage node), and operable to be conductive under the energy-storage state and nonconductive under the energy-release and idle states according to a conversion control signal Sc. The said isolation element 160 (e.g., a diode, a switch or the like) is coupled between the inductor output end 134 and the signal output end 120, and operable to be nonconductive under the energy-storage and idle states and conductive under the energy-release state. The said capacitor 170 is coupled between the signal output end 120 and the first voltage node V_{G}, and operable to output a capacitor current I_{C} to the signal output end 120 under the energy-storage and idle states. The said current sensing circuit 180 is operable to determine whether the inductor current I_{L} reaches a current threshold and thereby generate a current detection signal S_{I} in which the current threshold is above zero. For instance, if the converter 100 is able to supply a current whose average is Iₒᵤₜ to a load (which implies that the average of the inductor current outflowing from the signal output end 120 within the aforementioned operation cycle is I_{L}), the current threshold could be Iₒᵤₜ/K in which K is an integer or a fraction more than one and could be set in accordance with design resource or demand. The said control circuit 190 is coupled to the signal output end 120, the freewheel switch 140, the conversion switch 150 and the current sensing circuit 180, and operable to generate the conversion control signal Sc according to the DC output signal Vₒᵤₜ and generate the freewheel control signal S_{F} according to the current detection signal S_{I}.

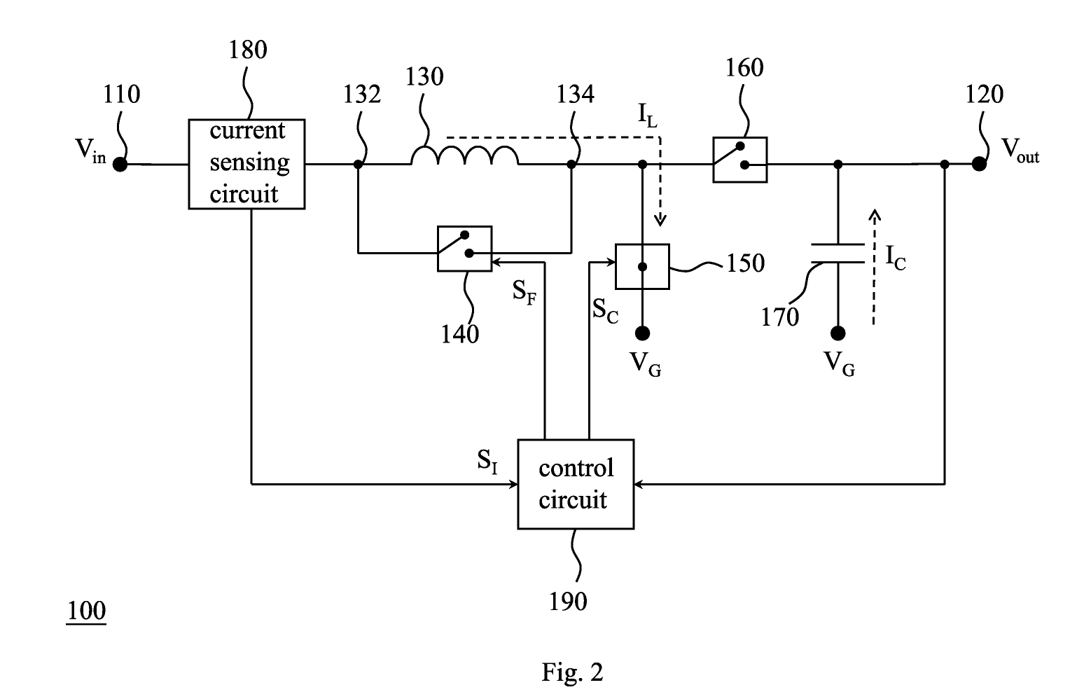

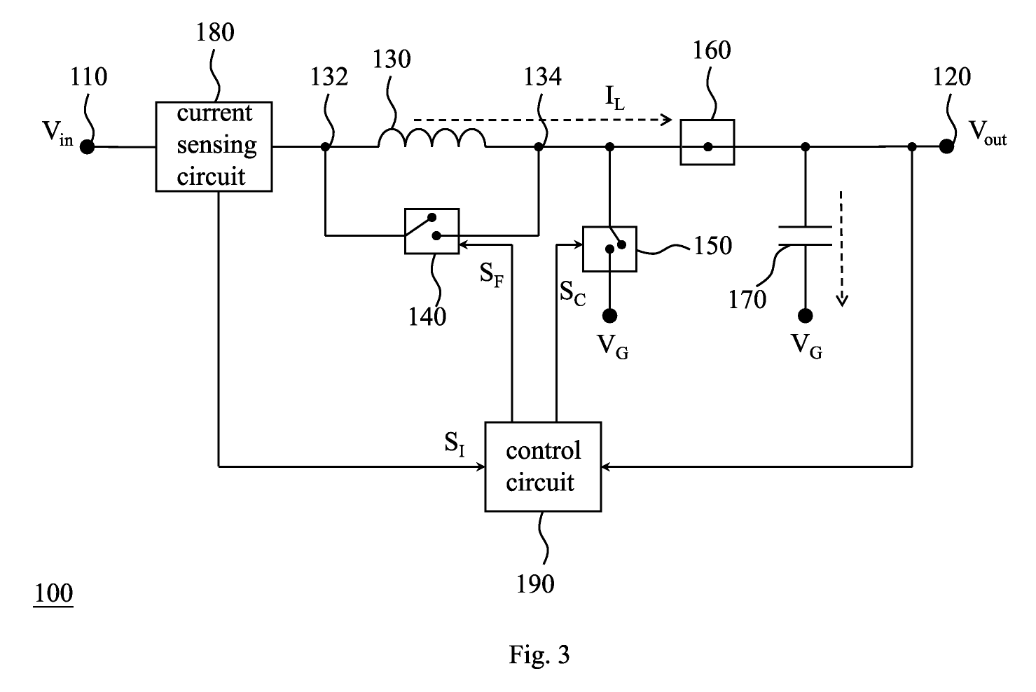

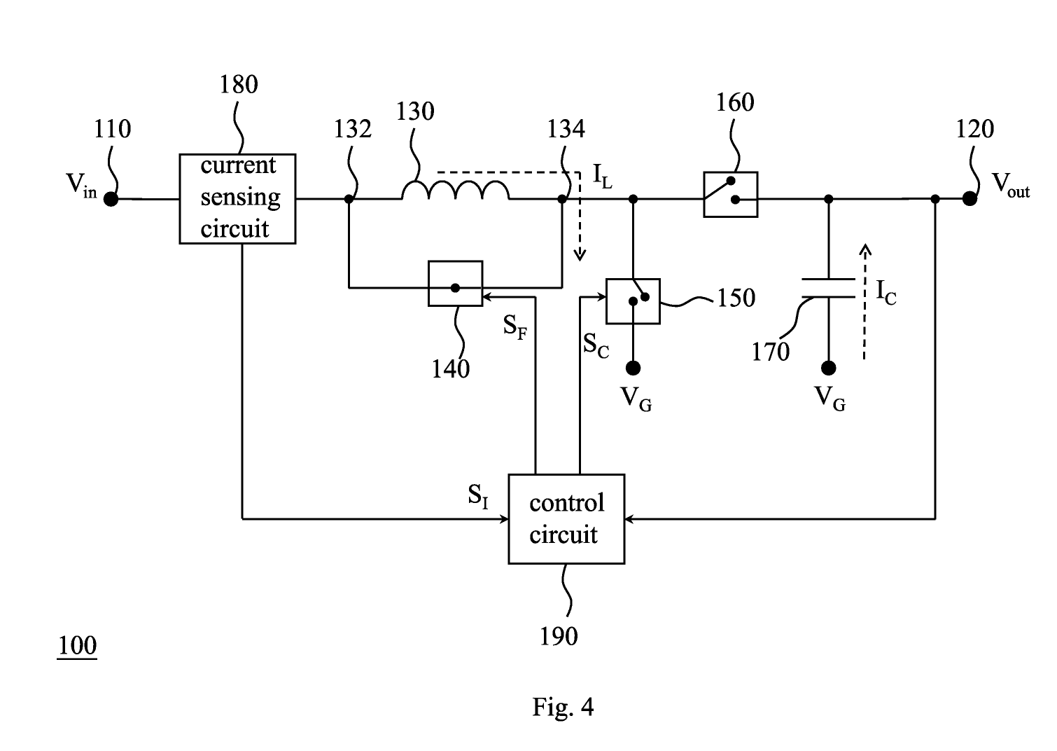

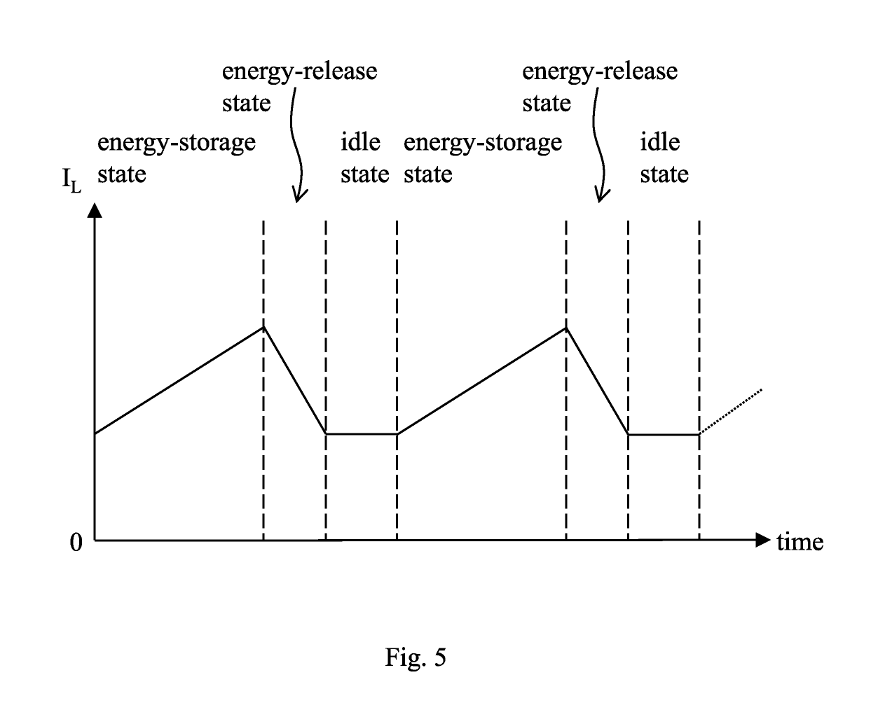

Please refer to FIG. 2 which illustrates how the DC-to-DC converter 100 of FIG. 1 operates in the energy-storage state. As it is shown in FIG. 2, under the energy-storage state, the freewheel switch 140 is nonconductive, the conversion switch 150 is conductive and the isolation element 160 is nonconductive. As a result, the DC input signal Vᵢₙ is transmitted in a loop along the signal input end 110, the inductor 130, the conversion switch 150 and the first voltage node V_{G}, so that energy could be stored by the inductor 130; meanwhile, the inductor current I_{L} increases by time as it is shown in FIG. 5, and the capacitor 170 outputs the capacitor current I_{C} to the signal output end 120. Please refer to FIG. 3 which illustrates how the DC-to-DC converter 100 of FIG. 1 operates in the energy-release state. As it is shown in FIG. 3, under the energy-release state, the freewheel switch 140 is nonconductive, the conversion switch is nonconductive, and the isolation element is conductive. Accordingly, the inductor current I_{L} flows into the signal output end 120, so that energy could be released from the inductor 130 to the signal output end 120; in the meantime, the inductor current I_{L} decreases by time as it is shown in FIG. 5 and the capacitor 170 is charged because of receiving a part of the inductor current I_{L}. Please refer to FIG. 4 which illustrates how the DC-to-DC converter 100 of FIG. 1 operates in the idle state. As it shown in FIG. 4, under the idle state, the freewheel switch 140 is conductive and the conversion switch 150 and the isolation element 150 are nonconductive. Therefore, the inductor current I_{L} circles in a loop along the inductor 130 and the freewheel switch 140, and thereby won't be reduced to zero in a limited time; meanwhile, the inductor current I_{L} is kept unchanged (or the reduction amount thereof is ignorable or acceptable to those who carry out the present invention in which the reduction amount could be less than a half of the foresaid current threshold (or a half of the maximum inductor current I_{L} after entering the idle state), and the capacitor 170 outputs the capacitor current l_{C} to the signal output end 120.

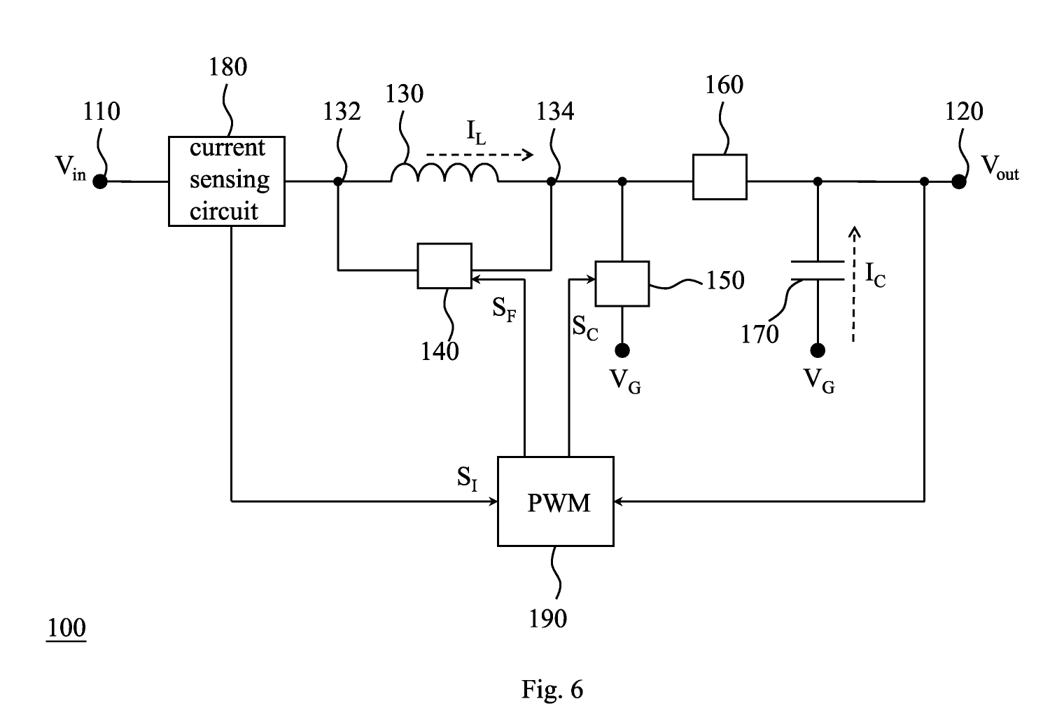

Please refer to FIG. 6 which illustrates an embodiment of the control circuit 190 of FIG. 1. In this embodiment, the control circuit 190 is a pulse width modulator (PWM) including a DC output signal decision unit (e.g., a voltage dividing circuit which is not shown in the figure) and a pulse width modulation unit (which is also not shown in the figure), operable to make the conversion switch 150 be conductive or nonconductive in accordance with the variation of the DC output signal Vₒᵤₜ, and operable to make the freewheel switch 140 be conductive or nonconductive according to the current detection signal S_{F} Furthermore, if the isolation element 160 is a switch in practice, the control circuit 190 is also operable to make the isolation element 160 be conductive under the energy-release state and nonconductive under the energy-storage and idle states. Since the pulse width modulator is a known device, the detail thereof is omitted while the existing disclosure is believed to be enough for the understanding and enablement of the present embodiment. Of course, other circuits capable of carrying out the said switch control could be treated as the control circuit 190 of the present invention.

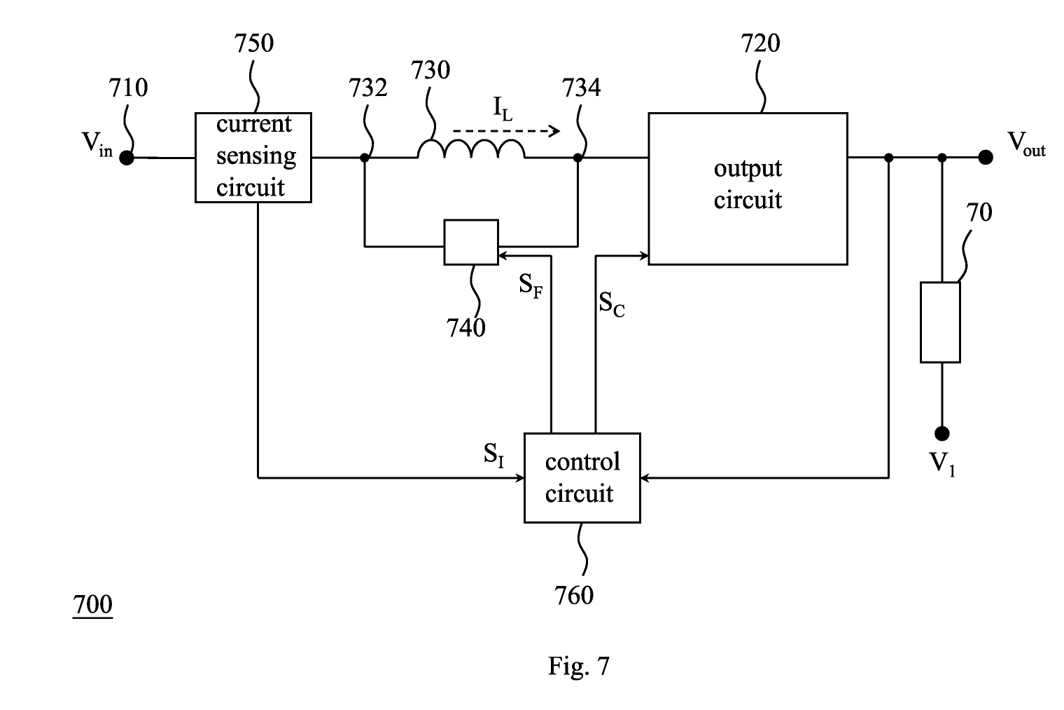

In addition to the embodiment of FIG. 1, another embodiment of the DCM DC-to-DC converter of the present invention is shown in FIG. 7, comprising: a signal input end 710; an output circuit 720; an inductor 730; a freewheel switch 740; a current sensing circuit 750; and a control circuit 760. The said signal input end 710 is operable to receive a DC input signal Vᵢₙ. The said output circuit 720 is operable to output a DC output signal Vₒᵤₜ to a load 70 which could be included in the converter 700 in this embodiment or independent of the converter 700. The said inductor 730 includes an inductor input end 732 coupled to the signal input end 710 and an inductor output end 734 coupled to the output circuit 720, and is operable to output an inductor current I_{L} according to the DC input signal Vᵢₙ under an energy-storage state, output the inductor current I_{L} according to the DC input signal Vᵢₙ and the DC output signal Vₒᵤₜ under an energy-release state, and maintain the inductor current I_{L} under an idle state. The said freewheel switch 740 is coupled to the inductor input and output ends 732, 734, and operable to be conductive under the idle state and nonconductive under the energy-storage and energy-release states according to a freewheel control signal S_{F} so that the freewheel switch 740 and the inductor 730 are operable to form a current loop under the idle state. The said current sensing circuit 750 is operable to determine whether the inductor current I_{L} reaches a current threshold and thereby generate a current detection signal S_{I} in which the current threshold is above zero. The said control circuit 760 is coupled to the signal output circuit 720, the freewheel switch 740 and the current sensing circuit 750, and operable to generate the freewheel control signal S_{F} according to the current detection signal S_{I} and operable to control the change of states from one of the energy-storage state, the energy-release state and the idle state to another (that is to say making the present state of the converter 700 change from one of the energy-storage state, the energy-release state and the idle state to another). The major difference between this embodiment and the embodiment of FIG. 1 is the output circuit 720 which may include a conversion switch, an isolation element, a capacitor and a signal output end such as those of FIG. 1 or may be realized by those of ordinary skill in the art with a proper circuit design in compliance with the teaching or suggestion of this specification. Since people of ordinary skill in the art can appreciate the detail and modification of the present embodiment by referring to the explanation of FIG. 1 through FIG. 6, which implies that the features of the foresaid DC-to-DC converter 100 can be applied here in a reasonable way, repeated and redundant explanation is therefore omitted while the existing disclosure is believed to be enough for understanding and enablement.

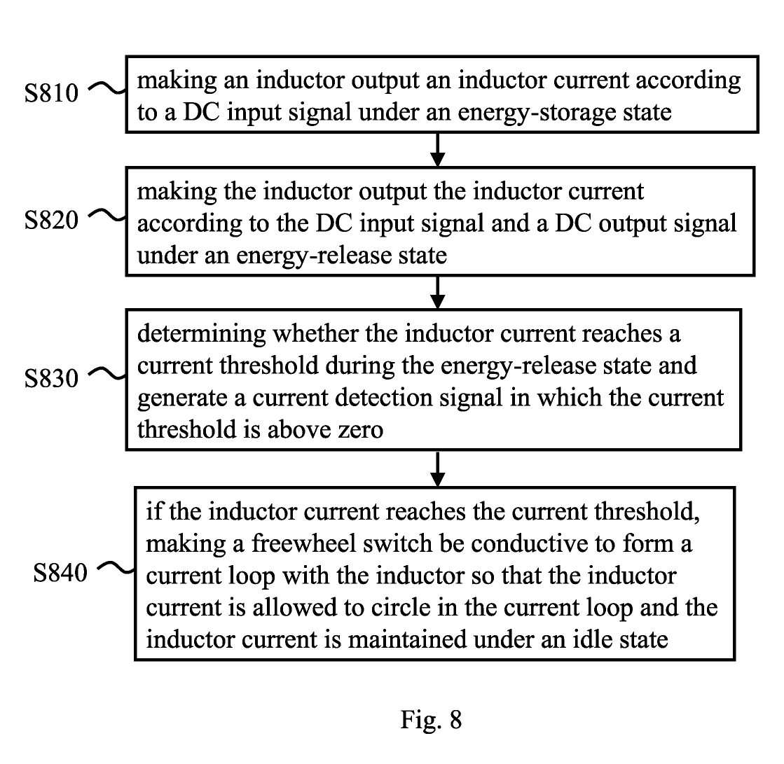

In addition to the above-disclosed converter, the present invention also discloses a DC-to-DC converting method of discontinuous conduction mode capable of preventing an inductor current from being reduced to zero under an idle state. As it is shown in FIG. 8, an embodiment of the converting method comprises the following steps:

Step S810: making an inductor output an inductor current according to a DC input signal under an energy-storage state.
Step S820: making the inductor output the inductor current according to the DC input signal and a DC output signal under an energy-release state.
Step S830: determining whether the inductor current reaches a current threshold during the energy-release state and generate a current detection signal accordingly in which the current threshold is above zero.
Step S840: if the inductor current reaches the current threshold, making a freewheel switch be conductive to form a current loop with the inductor so that the inductor current is allowed to circle in the current loop and the inductor current is maintained under an idle state.

In the above-mentioned steps, the duration of the energy-storage state, the energy-release state and the idle state is equal to the operation cycle of the DC-to-DC converting method. Additionally, the inductor current is kept substantially unchanged, or the reduction amount thereof is ignorable or acceptable to those carrying out the present embodiment. For instance, the reduction amount could be less than a half of the maximum inductor current I_{L} after entering the idle state, so as to ensure the effect of operation. However, people who carry out the present invention is free to set the bottom of the reduction amount of the inductor current on their own.

Since those of ordinary skill in the art can appreciate the detail and modification of this method embodiment by referring to the explanation of the foresaid device embodiments, which means that the features of the device embodiments can be applied to this method embodiment in an reasonable way, repeated and redundant description is therefore omitted while the existing disclosure is believed to be enough for understanding and enablement.

Please note that each embodiment in this specification includes one or more features; however, this doesn't mean that one carrying out the present invention should make use of all the features of one embodiment at the same time, or should only carry out different embodiments separately. In other words, if an implementation derived from one or more of the embodiments is applicable, a person of ordinary skill in the art can selectively make use of some or all of the features in one embodiment or selectively make use of the combination of some or all features in several embodiments to have the implementation come true, so as to increase the flexibility of carrying out the present invention.

In summary, the DCM DC-to-DC converter and converting method of the present invention are capable of preventing an inductor current from being reduced to zero under an idle state through the freewheel design, and therefore make improvements over the current drawing capability and noise reduction of the prior art.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A DC-to-DC converter of discontinuous conduction mode (DCM), comprising:
a signal input end operable to receive a DC input signal;
a signal output end operable to output a DC output signal;
an inductor including an inductor input end and an inductor output end operable to output an inductor current according to the DC input signal under an energy-storage state, output the inductor current according to the DC input signal and the DC output signal under an energy-release state, and maintain the inductor current under an idle state;
a freewheel switch, coupled to the inductor input and output ends, operable to be conductive under the idle state and nonconductive under the energy-storage and energy-release states according to a freewheel control signal so that the freewheel switch and the inductor are operable to form a current loop under the idle state;
a conversion switch, coupled between the inductor output end and a first voltage node, operable to be conductive under the energy-storage state and nonconductive under the energy-release and idle states according to a conversion control signal;
an isolation element, coupled between the inductor output end and the signal output end, operable to be nonconductive under the energy-storage and idle states and conductive under the energy-release state;
a capacitor, coupled between the signal output end and the first voltage node, operable to output a capacitor current to the signal output end under the energy-storage and idle states;
a current sensing circuit operable to determine whether the inductor current reaches a current threshold and thereby generate a current detection signal in which the current threshold is above zero; and
a control circuit, coupled to the signal output end, the freewheel switch, the conversion switch and the current sensing circuit, operable to generate the conversion control signal according to the DC output signal and generate the freewheel control signal according to the current detection signal.

2. The DC-to-DC converter of claim 1, wherein the isolation element includes a diode or a switch.

3. The DC-to-DC converter of claim 1, wherein the first voltage node is a grounding voltage node.

4. The DC-to-DC converter of claim 1, wherein the control circuit includes a pulse width modulator.

5. The DC-to-DC converter of claim 1, wherein the duration of the energy-storage state, the energy-release state and the idle state is equivalent to the cycle of the DC-to-DC converter.

6. The DC-to-DC converter of claim 5, wherein the inductor current is kept unchanged under the idle state, or the amount of reduction in the inductor current under the idle state is less than a half of the current threshold.

7. A DC-to-DC converting method of discontinuous conduction mode, comprising:
making an inductor output an inductor current according to a DC input signal under an energy-storage state;
making the inductor output the inductor current according to the DC input signal and a DC output signal under an energy-release state;
determining whether the inductor current reaches a current threshold during the energy-release state and generate a current detection signal accordingly in which the current threshold is above zero; and
if the inductor current reaches the current threshold, making a freewheel switch be conductive to form a current loop with the inductor so that the inductor current is allowed to circle in the current loop and the inductor current is maintained under an idle state.

8. The DC-to-DC converting method of claim 7, wherein the duration of the energy-storage state, the energy-release state and the idle state is equivalent to the cycle of the DC-to-DC converting method.

9. The DC-to-DC converting method of claim 7, wherein the inductor current is kept unchanged under the idle state, or the amount of reduction in the inductor current under the idle state is less than a half of the current threshold.

10. A DC-to-DC converter of discontinuous conduction mode, comprising:
a signal input end operable to receive a DC input signal;
an output circuit operable to output a DC output signal;
an inductor including an inductor input end coupled to the signal input end and an inductor output end coupled to the output circuit, operable to output an inductor current according to the DC input signal under an energy-storage state, output the inductor current according to the DC input signal and the DC output signal under an energy-release state, and maintain the inductor current under an idle state;
a freewheel switch, coupled to the inductor input and output ends, operable to be conductive under the idle state and nonconductive under the energy-storage and energy-release states according to a freewheel control signal so that the freewheel switch and the inductor are operable to form a current loop under the idle state;
a current sensing circuit operable to determine whether the inductor current reaches a current threshold and thereby generate a current detection signal in which the current threshold is above zero; and
a control circuit, coupled to the signal output circuit, the freewheel switch and the current sensing circuit, operable to generate the freewheel control signal according to the current detection signal and control the change of states from one of the energy-storage state, the energy-release state and the idle state to another.
